(19) United States
(12) Patent Application Publication
(10) Pub. No.: US 2010/0126645 A1
(43) Pub. Date: May 27, 2010

(54) MOTORCYCLE TIRES AND METHOD TO IMPROVE PERFORMANCE AND WEAR RESISTANCE OF MOTORCYCLE TIRES

(76) Inventors: Samuel Santana Barboza, Santo Andre (BR); Vinicius Barbosa Cruz, Santo Andre (BR)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/450,706

(22) PCT Filed: Apr. 13, 2007
(86) PCT No.: PCT/BR2007/000093

§ 371 Date: Feb. 1, 2010

(51) Int. Cl. B60C 11/03; B60C 11/13

(52) U.S. Cl. 152/209.11

(57) ABSTRACT

Pairs of motorcycle tires and a method for improving performance and resistance to wearing, consists of a tread including grooves, the tread consisting of a central area, sided by intermediate side areas and by projection areas, the latter being adjacent to the external borders of such tread. The sea/land ratio in the central area of the front tire is between 15% and 30%; the sea/land ratio in such central area of the rear tire is substantially lower than that of the other areas of the tire, the value being lower than 70%; the sea/land ratio in the intermediate side areas of the front tire and rear tire is between 20% and 40%; and the sea/land ratio in the projection areas of the front tire and rear tire is between 10% and 30%.

### FIELD OF INVENTION

This invention refers to a family of tires, comprising pairs of front and rear tires, each pair being respectively assembled on one front wheel and on one rear wheel of a motorcycle, each of such pairs of tires comprising one specific tread provided with a plurality of grooves.

### DESCRIPTION OF THE STATE OF THE ART

In the field of motorcycle tires and, in particular, in the field of tires, for the so-called low CC motorcycles, one of the hardest problems to be solved by tire manufacturers is to improve performance as regards mileage output, both on wet and dry ground, keeping uniform wearing and traction characteristics of the tires, while finding the best possible compromise between these characteristics.

As it is well known by anyone skilled in the art, this is a problem particularly hard to be solved as these characteristics conflict to each other, because the performance on wet ground is largely related to the presence, on the tread, of a sufficient number of grooves that are capable of draining the water present on the area where the tires touch the ground, while the mileage output, the uniform wearing and the traction characteristics of the tires—to the contrary—would be beneficially influenced by the reduction in the number of these grooves.

This problem is additionally worsened by the fact that the performance on wet ground must be assured both when running along straight sections and along a curve.

Accordingly, there is a major difference in these two running conditions, when on wet ground: in straight sections, the contact of the rear tire with the ground occurs along a relatively dry strip, the water from which was drained by the front tire. On the other hand, on curved sections, such tires run through different paths, thus resulting in both the rear and front tire touching the wet ground. Considering that the vehicle tilts when going on a curve, it results that the area of contact of both tires is no longer centered in the equatorial region of the tread, but is displaced to one of the sides to a higher or lower extent, depending on the radius of the curve and speed of the vehicle. Thus, the design of the tread must consider such conditions so as to insure efficient draining, keeping adherence to the paving, a condition that is indispensable for the handling of the vehicle.

Some patent documents mentioned below reflect the several attempts to solve the problem of obtaining stability without compromising the wearing characteristics of the tires.

U.S. Pat. No. 3,730,245 “Pneumatic tire for high-speed motorcycle” (May 1973) shows, in its FIG. 5A, reproduced in this application as FIG. 1, a tread provided with a straight circumferential groove g_{c} aligned with the center of equatorial plane, sided on the left and on the right by circumferential grooves gᵣ, the former making sequences of near-elliptic sections and the latter, external, straight in format and parallel to the groove g_{c}. The drawing further comprises a series of transversal grooves gₘ uniformly spaced and perpendicular to groove g_{c}, that is, to the direction of movement of the tire. This tread shows to be adequate for dry floor, however on wet floor the draining is poor, due to the direction of the grooves gₘ.

U.S. Pat. No. 4,364,426 “Motorcycle tire tread” (December, 1982) shows the drawing of a tread, reproduced in FIG. 2 of this application, comprising a plurality of grooves substantially transversal and parallel, extending between the right and left side areas of such tread, in which circumferential grooves are provided in zigzag, the external vertices of which are connected to water draining channels. The fact that such grooves keep substantially the same direction throughout their length (between the right and left areas of the tread) results in a material difference in water draining between the center and each of the borders. So, considering the running direction DR indicated in the figure, the water will be more efficiently drained in tₑ section, and less efficiently in t_{d} section, and vice-versa in case the running direction is opposite to the indicated one. Moreover, this application does not specify whether it refers to the front or rear tire, which should have distinct characteristics due to their functions being different.

U.S. Pat. No. 6,276,415 “Pneumatic radial tire for motorcycle” (August, 2001) presents a drawing—reproduced in FIG. 3—in which transversal grooves are provided, symmetrically positioned in relation to the central line of the tread, so as to avoid the difference in water draining indicated in the subject matter of the prior patent. However, the drawing now presented results in large rubber areas, which adversely affects performance. Moreover, the treads described in that patent only refer to front tires, and it says nothing about rear tires.

Patent document JP 2000043509 “Pneumatic tire for motorcycle” shows a drawing—reproduced in FIG. 4—comprising two circumferential grooves 3 and 4 in zigzag on both sides of equator line 2, such grooves communicating with transversal grooves 6 positioned at an angle with such axis, extending from the central area to the intermediate area of the tread, having in the edge a groove 5 in an approximate angle of 100° with the prior one and extending from the intermediate area to the side area of the tread without, however, reaching its border. In a position approximately central to groove 6 and at a right angle with it, there is a secondary groove that is narrower and harder than groove 5. This document does not indicate whether the tread shown relates to the front or rear tire, and, in both cases, the adherence in curves is adversely affected due to the near total absence, in the side bands, of water draining grooves.

US Patent Application 2005/0115653 “Pneumatic tire for motorcycle” shows a drawing—reproduced in FIG. 5—that comprises a pair of circumferential zigzag grooves in the central area of the tire and a plurality of diagonal curved grooves, extending between this central area and the sides of the tread. The application does not inform whether it refers to the front or rear tire and, in the latter case, there will be considerable wearing due to the high value of the “sea/land” ratio in the central area.

### PURPOSES OF THE INVENTION

In view of the foregoing, this invention has as purpose to provide tires with optimized characteristics of adherence to the pavement, both on dry and wet floors.

Another purpose consists of providing the tires with higher resistance to wearing.

Another purpose consists of providing tires that permit to easily check the level of wearing on the tread.

### SUMMARY OF THE INVENTION

According to this invention, the Applicant noticed that the problem of improving the mileage output performance both on wet and dry floors, uniform wearing and traction characteristics for motorcycle tires may be solved by an approach based on a general outlook, simultaneously considering both front and rear tires.

From this point of view, the Applicant found out that the problem mentioned above can be solved by a joint combination of a front tire and a rear tire, each of them having a tread pattern provided with specifically designed characteristics as regards the dimensions and positioning of the grooves. These patterns on the tread take into consideration the specific functions of each tire in the vehicle, once the main function of the front tire is to provide the directional control, and the rear tire is responsible for its driving, besides bearing most of the weight.

Taking into consideration the applications to which they are intended, the tires presented in this invention comprise three preferred types of embodiment, namely, tires for urban use on paved floor, sportive high-speed tires and “endurance” tires for unpaved floors.

In order to better understand the following matter, some definitions are presented below, taking as reference FIG. 6, which represents a considerably simplified cross-section view of a tire:

tread, referred with letter B in the figure, is the portion of the tire intended to touch the paving, either in straight paths or in curves. The surface of the tread is provided with a plurality of low-relief grooves having, among other functions, that of draining water from the ground in contact with the tire. As shown by FIG. 6, the tread is divided into five parallel areas, that will be described below;

axial development is the tread width when developed on a flat surface, that is, the distance between H-H borders measured along the tire surface;

equatorial plane is the plane parallel to the main plane of the tire, dividing it into two symmetric halves. The intersection of this plane with the external surface of the tire defines the X-X longitudinal axis of the tread. The direction perpendicular to this axis, that is, the one which goes from one to the other border H of the tread is defined as the “axial” direction.

Central area E of the tread is the circumferential strip that extends astride the X-X longitudinal axis, occupying, in this invention, from 10% to 25% of the axial development;

intermediate side areas C and D in the figure, are strips that extend in parallel to X-X axis along the whole circumference of the tire, in both sides of the so-called central area E, occupying, in this invention, from 20% to 30% of the axial development of the tread;

projection areas F and G in the figure are strips that extend in parallel to X-X axis along the whole circumference of the tire, between the limits of the intermediate side areas and the borders H of the tread, occupying, in this invention, from 10% to 15% of the axial development of the tread;

“sea/land” ratio is the ratio between the area occupied by the grooves or channels provided in a certain portion of the tread and the total area of such portion;

The way in which the tire touches the floor is a result of the path of the vehicle. In a straight path, the situation is as shown in FIG. 7, the contact of tire 10 with paving 11 occurring mainly or exclusively along the central area E. In a curve, the motorcycle tilts as shown in FIG. 8, and the contact of tire 10′ with the paving now occurs along areas C and F, and, in steeper inclinations—corresponding to sharper curves or higher speeds—only area F will touch paving 11.

When running on wet floor, it is essential to obtain good adherence of the tires in curved paths, so as to assure the stability of the vehicle. Such purpose is reached by the family of tires of this invention, causing the sea/land ratio in intermediate side areas to be higher than sea/land ratios in the central area and in projection areas, both in front and rear tires.

Advantageously, this characteristic of the intermediate side areas, axially opposed, improves the water draining capacity of the tires, when they move along a curve, that is, when the tires are tilted to provide the leaning impulse necessary to counterbalance the centrifuge power.

According to another characteristic of the invention, in rear tires the sea/land ratio in central area E is substantially below that of the other areas of the tread.

According to another characteristic of the invention, the rear tire presents higher axial development of the tread, that is, the tread is wider than in the front tire.

According to another characteristic of the invention, the grooves that make the drawings of the tread comprise, at least, one substantially straight section. Such grooves may further comprise two or more substantially straight sections engaged among them.

According to a further characteristic of the invention, the grooves that make the drawings of the treads comprise a plurality of transversal grooves laid in angle in relation to the X-X axis, that is, to the running direction DR of the tire.

According to another characteristic of the invention, such transversal grooves comprise one first set of transversal grooves, alternately positioned in relation to one and the other from the X-X longitudinal axis, and directed in an angle in relation to it, and such grooves extending to the external borders H of the tread, where they end. Preferably, the portion of the grooves of such first set, located in the intermediate side areas, defines with the running direction of the front tire an angle from about 50° to about 75° and, even more preferably, from about 60° to about 70°.

According to another characteristic of the invention, the grooves comprised in that first set present a progressive increase in its cross-section when approaching such external borders H.

According to another characteristic of the invention, such increase is provided by the increase in the width of the grooves towards the borders.

According to another characteristic of the invention, in a first and second preferred embodiment, the tread of front tires comprises, at least one circumferential groove extending in the equatorial plane of the front tire within such central area E, and the internal ends of the grooves comprised in said first set are joined to such circumferential groove.

According to another characteristic of the invention, in those first and second embodiments, the tread of the front and rear tires is provided with a second set of intermediate grooves between the grooves of the first set, equally positioned in both sides of the X-X longitudinal axis. Preferably, the first end of the grooves of that second set is located at about the borderline between the central area and the intermediate side area, and the second end is located in the projection area, without reaching the border of the tread.

According to another characteristic of the invention, in those first and second embodiments, a third set of transversal grooves is provided, angularly laid out and alternately positioned in the longitudinal direction of the tread, and such grooves being fully contained in projection areas F and G.

Advantageously, those second and third sets of additional transversal grooves exercise the double function of increasing the water draining capacity of the tread, while optimizing its regularity of wearing as it helps reach proper balance between the area occupied by the grooves (“sea”) and the area occupied by the rubber portions of the tread.

According to another characteristic of the invention, such transversal grooves of the first and second sets are provided with branched grooves that form, with the running direction (DR) of the tire—or with X-X axis—angles comprised between about 5° and about 25°.

According to the first preferred form of embodiment, such branched grooves are bridges connecting grooves between the transversal grooves of those first and second sets. Thus, it is advantageously possible to improve the water draining capacity of the front tire so that the rear tire moves on a substantially water-free track, which can be attributed to the action of the water draining exercised both by the circumferential groove and the plurality of such connection grooves and, further, by the plurality of transversal grooves the end of which is located within the central area of the tread.

Due to this advantageous technical effect, provided by the front tire, the tread of the rear tire may be properly designed to optimize its wear resistance and traction performance through the provision of a sea/land ratio substantially minimized in the central area of the tread, extending astride the equatorial plane of the rear tire, and with a specific axial development.

In addition, at least one circumferential groove extending in the equatorial plane of the front tire, in the first and second preferred embodiments of the invention, also acts as a folding element during the running of the tire, thus reaching the additional advantageous technical effect of increasing the running stability of the front tire.

Consequently, the pairs of tires of the first and second preferred embodiments of the invention permit to reach the following important advantages in relation to the tires of the prior art, for the same kind of use:

a) An improvement in the front tire's capacity of draining water under the contact patch with the floor, so as to better control any hydroplaning phenomena;

b) An improvement in front tire's driving stability on straight paths;

c) An improvement in the rear tire's uniformity of wear with a substantial elimination of those phenomena of irregular and non-homogeneous wearing of the rubber portion of the tread, referred to in the art by the expression “detachment from the floor”.

d) An improvement in the wear resistance of the rear tire, increasing the mileage output of the tire.

According to another characteristic of the invention, in rear tires, the internal portion of at least some grooves, that extend in the direction from the projection area to the center, surpasses the X-X longitudinal axis in the central area of the tread. Advantageously, this feature permits to visually check the degree of wearing of the tread, besides contributing to drain the water present in the contact patch of the tire with the floor.

According to a preferred form of embodiment of this invention, the rear tire also comprises intermediate transversal grooves formed in the tread in both sides of X-X axis, intercalated between the grooves mentioned above, and with an internal end located approximately at the borderline between the central area and the intermediate side area, the second end being located in the projection area, without reaching the outer edge of the tread.

As it occurs with the front tire, these additional grooves advantageously exercise the double function of increasing the water draining capacity of the tread, especially when the rear tire moves along a curve, while optimizing its wearing regularity as it helps reach proper balance between the area occupied by the grooves and the area occupied by the rubber portions of the tread.

According to another feature of the invention, in a third preferred embodiment of the invention, the drawings of treads of front and rear tires are similar. These drawings comprise a fourth set of transversal grooves laid out at an angle and alternately positioned along the tread, such grooves having a first internal end, located on the intermediate side area and the external end ending on border H of the tread. Further in accordance with such form of embodiment, the tread comprises a fifth set of grooves, intercalated between the grooves of said fourth set and substantially parallel to them having a first end located in the intermediate side area C or D, crossing the central area E and the intermediate side area of the opposed side and ending on projection area F or G, without reaching its external border. Preferably, such grooves define with X-X axis of the tread an angle from about 50° to about 75° and, more preferably, from about 60° to about 70°.

Additionally, in the tread of the tires under the third preferred embodiment, such transversal grooves are interconnected by bridging grooves, substantially positioned in intermediate side areas C and D and forming with X-X axis of the tread an angle comprised between 10° and 30°. Preferably, such angles are approximately complementary to the angles formed between such transversal grooves and the X-X axis.

Thus, it is advantageously possible to improve the water draining capacity of the rear tire in curved paths, when this tire is not aligned with the front tire.

According to another aspect of the invention, a method is provided to improve the performance both on wet and dry floors of a motorcycle equipped with a front tire and a rear tire, comprising, in particular, the steps of:

a) improving the water draining capacity of the front tire under its contact patch with the ground within the central area astride the equatorial plane of the front tire, by providing at least one groove at least partially extending over said central area;

b) improving the traction capacity and the durability of the rear tire by providing a considerably reduced sea/land ratio within the central area of the tread extended over the equatorial plane of the rear tire, such ratio being substantially lower than that in the other areas of the tread;

c) improving the water draining capacity of both tires, when running on a curved path, through the provision of a sea/land ratio in the intermediate side areas higher than sea/land ratio in the central and projection areas.

According to a preferred form of embodiment of this invention, step (a) is performed by providing the front tire with a plurality of transversal grooves with an axially internal end located within such central area of the tread in the front tire and alternately extending from such central area towards projection areas axially opposed of the tread external to such central area of the front tire.

Preferably, step (a) is performed by the provision of a sea/land ratio between about 10% and about 30% within the central area of the tread of the front tire, and this area having a width from about 10% to about 25% of axial development of such tread.

Preferably, step (a) is performed by the provision of, at least, one circumferential groove extending in the equatorial plane of the front tire and, even more preferably, at least some of said transversal grooves being connected with said at least one circumferential groove.

Thus, it is advantageously possible to optimize the water draining capacity of the front tire under its contact patch with the ground, both when the motorcycle moves along a straight line section and along a curve.

Preferably, step (c) is performed by the provision of a plurality of transversal grooves, defining a sea/land ratio between about 20% and about 40% within axially opposed intermediate side areas located between the central area and the projection areas of the tread, each of said intermediate side areas having a width from about 20% to about 30% of the axial development of said tread of the front tire.

Preferably, the above mentioned transversal grooves formed in the tread of the front tire define with the running direction of the front tire an angle from about 50° to about 75° and, more preferably, from about 60° to about 70°.

According to a preferred form of embodiment of this invention the method also comprises the step of improving the water draining capacity of the rear tire, when moving along a curve, through the provision in its tread of a plurality of transversal grooves, having an axially internal end located within a central area of the tread of the rear tire and alternately extending from the central area towards axially opposed projection areas external to such central area.

Preferably, such plurality of transversal grooves formed in the tread of the rear tire defines a sea/land ratio from about 20% to about 40% within the axially opposed intermediate side areas. Preferably, in addition, the transversal grooves formed in the tread of the rear tire define with the running direction of the front tire an angle from about 50° to about 75° and, more preferably, from about 60° to about 70°.

### DESCRIPTION OF FIGURES

Other characteristics and advantages will be more easily apparent by the following description of preferred embodiments of the invention, provided on an illustrating and not limiting basis, reference being made to the corresponding drawings, in which:

FIGS. 1 to 5 show several treads configured according to the previous art.

FIG. 6 shows a cross-section of the tire, highly simplified, indicating the areas in which the tread is divided.

FIGS. 7 and 8 show the contact of the tire with the floor in the situation of a straight line path and in a curved path.

FIGS. 9 and 10 show the treads, respectively, of the front and rear tire in a first preferred embodiment of the invention.

FIGS. 11 and 12 show the treads, respectively, of the front and rear tire in a second preferred embodiment of the invention.

FIGS. 13 and 14 show the treads, respectively, of the front and rear tire in a third preferred embodiment of the invention.

FIG. 15 shows the main grooves that configure the drawing of the front tire tread in a first embodiment of the invention.

FIG. 16 shows the main grooves that configure the drawing of the rear tire tread in a first embodiment of the invention.

FIG. 17 shows the main grooves that configure the drawing of the front tire tread in a second embodiment of the invention.

FIG. 18 shows how the rear tire tread layout is configured in a second embodiment of the invention.

FIG. 19 shows how the front and rear tires tread layout is configured in a third embodiment of the invention.

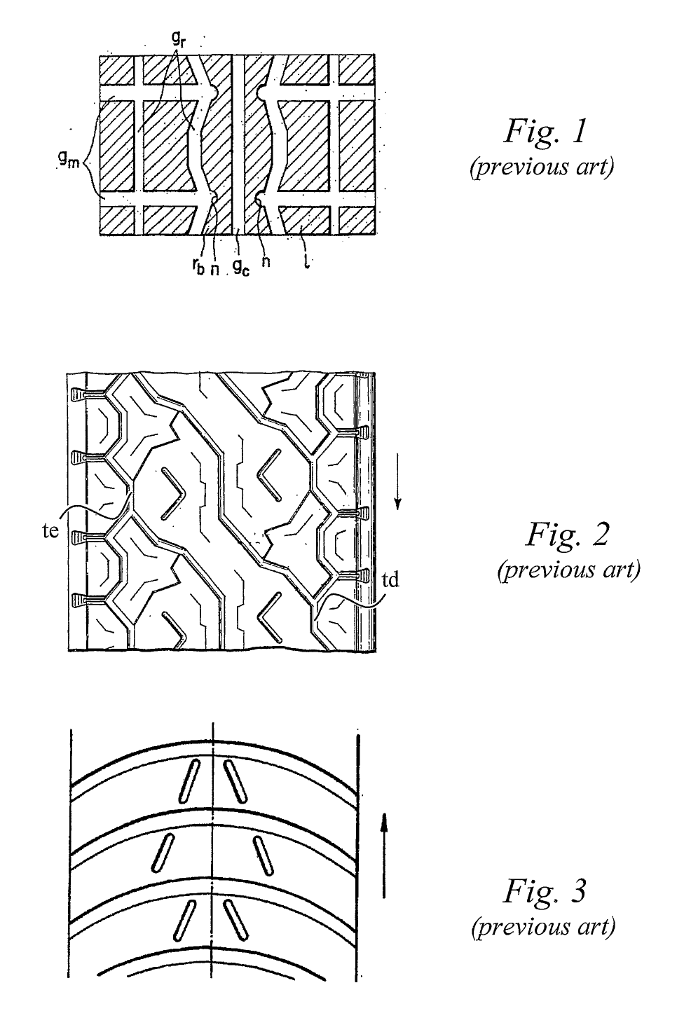

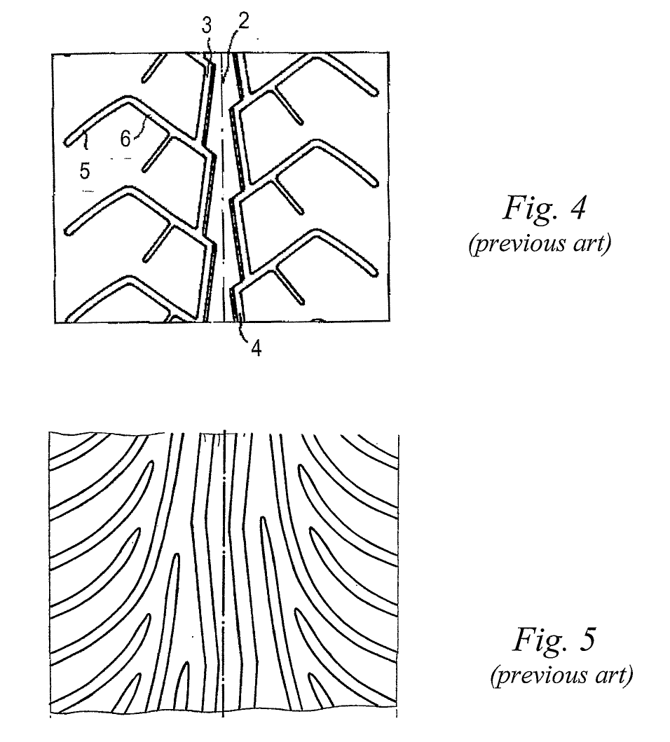

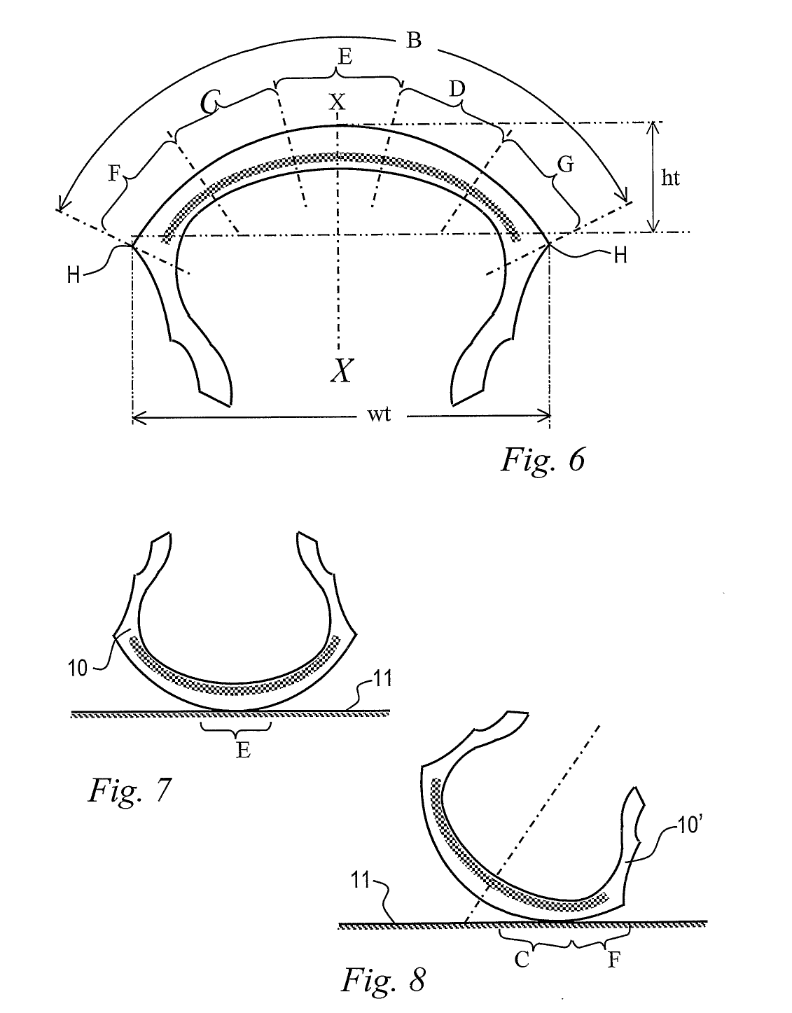

### DETAILED DESCRIPTION OF THE INVENTION

As it is known, in order to have a good directional stability and good capacity of controlling the vehicle, the front tire must have an appropriate small width section, in relation to the rear tire, which brings about the need for a specific transversal curvature.

The extension of this transversal curvature is defined by the specific value of the relation between ht height—between the crown of the tread and the line that passes through borders H-H of the tread—and the distance wt measured along the tire chord between such axially opposed borders H-H.

This ratio is called tire curvature ratio.

The curvature ratio for front tires of motorcycles is usually higher than 0.3 and, in any case, is always higher than that for the corresponding rear tire.

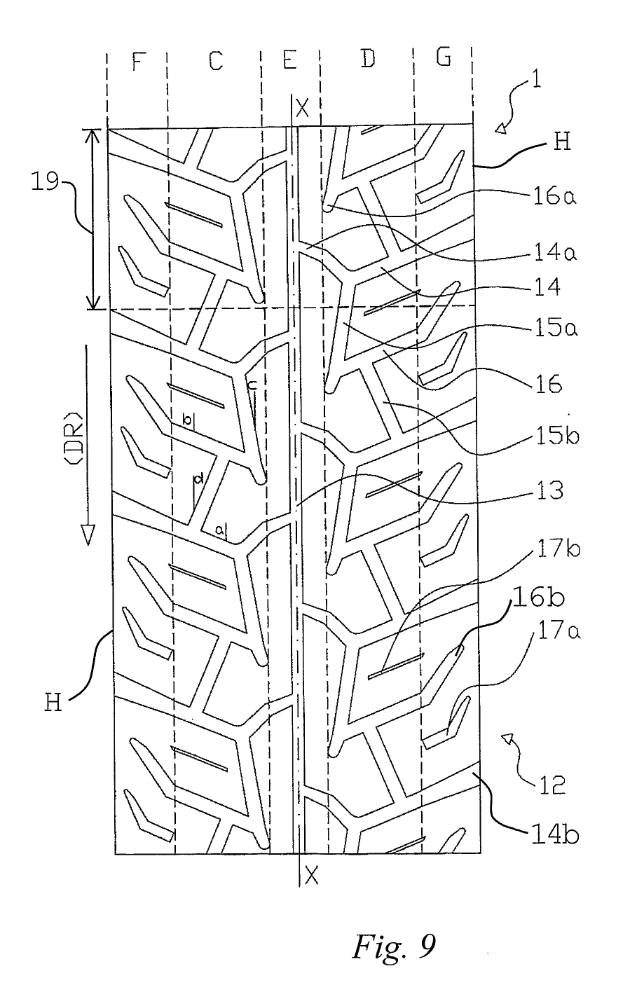

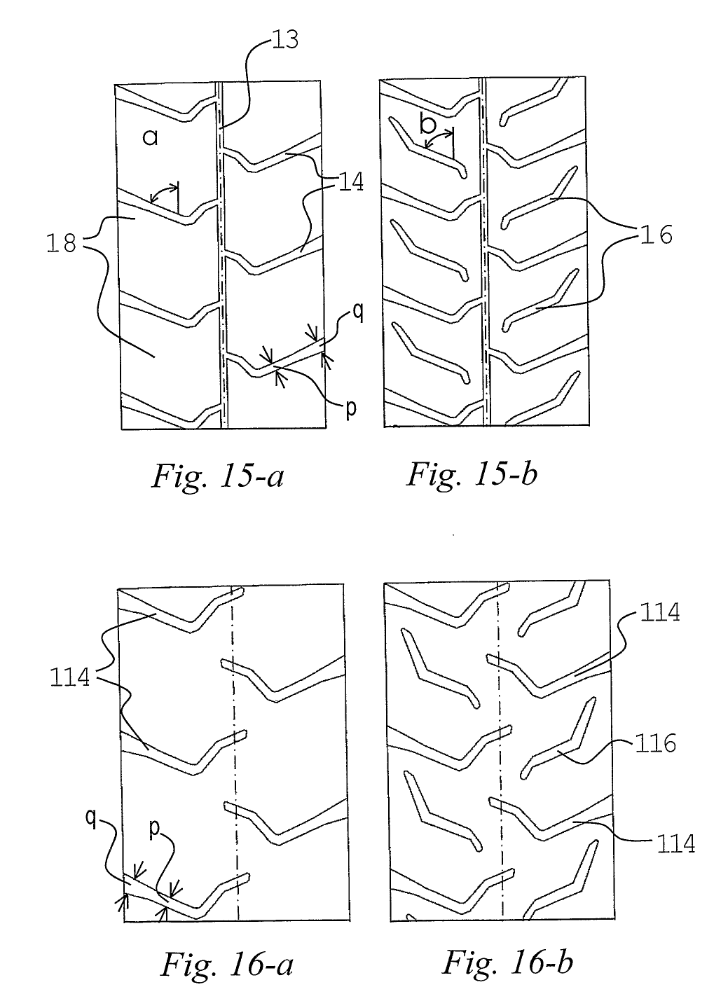

In the first preferred form of embodiment, shown in FIGS. 9 and 15, the tread 12 of the front tire comprises:

a) one circumferential groove 13 extending within a central area located over the equatorial plane X-X, and

b) a first plurality of transversal grooves 14 with an axially internal end 14a located within a central area E of the tread 12 and alternatively extending towards the axially opposed projection areas G, F of tread 12, and ending on the external borders of such projection areas.

The above mentioned circumferential 13 and transversal 14 grooves define in tread 12 a plurality of rubber portions, all of them indicated by reference 18 in FIG. 15-a, generally extending in a direction substantially transversal to the running direction of the tire, which is indicated by arrow DR in FIG. 9. In this figure and in FIGS. 15a and 15b, a progressive increase can be observed in the width of transversal grooves 14 towards the borders, that is, the dimension q is larger than dimension p.

Preferably, the central area E of the tread 12 extends astride the X-X equatorial plane of front tire 1 and has a width from about 10% to about 25% of the axial development of the tread 12. In the example embodiment of the figure, the width of this area is of 16%.

In the preferred form of the embodiment, in order to improve the water draining capability of front tire 1, central area E of tread 12 has a sea/land ratio between about 10% and about 30%, and the value of this ratio in the tread, shown in FIG. 9, equals 26%.

Preferably, in intermediate side areas C, D of front tire 1, with a width from about 20% to about 30% of the axial development of the tread, a sea/land ratio from about 20% to about 40% is provided, and this ratio, as shown in FIG. 9, equals 31%.

Preferably, in projection areas F and G, with a width from about 10% to about 15% of the axial development of the tread, a sea/land ratio from about 10% to about 30% is provided, and this ratio is equal to 24% in the tread shown in FIG. 9.

Preferably, the portions of the transversal grooves of the first set 14 located in intermediate side areas C and D form with the rolling direction DR of front tire 1, which is parallel to X-X axis, an angle a from about 50° to about 75° and more preferably, from about 60° to about 70°, this angle being equal to 67° in FIG. 9.

In the first preferred form of embodiment shown in FIGS. 9 and 15, the internal extremities 14a of the transversal grooves of the first set 14 are connected to the circumferential groove 13. Besides, said grooves of the first set are distributed along the tread 12 in a staggered manner, alternately in one and the other side of X-X axis.

In the tread shown in FIGS. 9 and 15, transversal grooves 16 are further provided, comprising a second set of grooves, forming in both sides of X-X axis, intercalated between grooves 14. Such intermediate grooves 16 have a first axially internal end 16a substantially located in the border line between the central area E and the intermediate side areas C, D, and the second axially external end 16b located in the projection area F, G of tread 12. In this second set of grooves 16, the central portion—located in the intermediate side areas C or D—forms with the rolling direction of the tire an angle b from about 50° to about 75° and, more preferably, from about 60° to about 70°, this angle being equal to 67° in FIG. 9. Thus, said transversal grooves 14, 16 of the first and of the second sets formed in the tread 12 of the front tire 1 have their main central portions substantially parallel to each other. The angulation of the end portions 16a and 16b in relation to the central portion of grove 16 provides, respectively, a better water ingress and a better water exit to and from said grove. The angulation of portion 14a also facilitates the water ingress to grove 14.

With the purpose of improving the draining when in curved paths, providing a proper balance between the areas occupied by the grooves and those occupied by the rubber portions in projection areas G and F, the latter are further provided with grooves 17a, partly substantially parallel to grooves 16 and partly parallel to groove ends 16b, which improve the draining in sharp curves, when the contact patch where the tire touches the floor includes these areas. Moreover, the intermediate side areas C and D are provided with narrow slots 17b, substantially parallel to the grooves 14, the function of which is to increase the flexibility of the tire in these areas.

Further in accordance with the illustration of FIG. 9, said transversal grooves are provided with branches 15a and 15b, which in the first preferred form of embodiment comprise bridging grooves between said transversal grooves. Such branches form with the rolling direction DR angles c and d comprised between 5° and 25°. In FIG. 9, these angles are equal to 9° and 23°, respectively. Such bridging grooves contribute to drain the water when the contact patch comprises areas C or D.

As shown in FIG. 9, the drawing of the tread comprises a sequence of substantially identical modules 19, which are repeated along the entire circumference of the tread. Preferably, the pitch of these modules is comprised between 30 mm and 150 mm. In terms of circumference of the tire, the pitch of these modules is between 1/10^{th} and 1/50^{th} of such circumference.

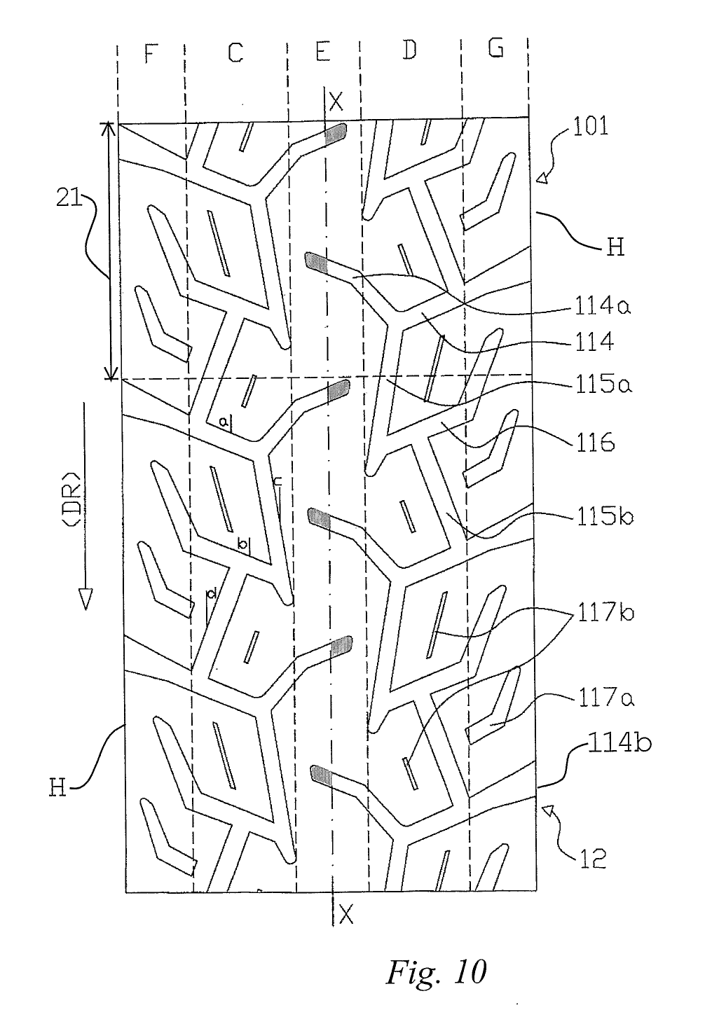

FIGS. 10 and 16 show the tread of the rear tire, which is used together with the front tire 1 shown in FIG. 9, according to the first embodiment of the invention.

As previously shown and according to the principles of the invention, the tread of rear tire 101 shows a larger width than that of the corresponding front tire, observing in FIG. 10 that the sea/land ratio inside central area E is substantially lower than that of the front tire besides being considerably smaller than in the other areas. This ratio is comprised between about 5% and 20%, and its value is equal to 10% in the example drawing in FIG. 10.

In this first embodiment, tread 12 of rear tire 101 comprises a plurality of transversal grooves 114 that alternately extend from central area E to the external borders of projection areas F, G. Theses grooves have their axially internal portion 114a partially crossing such central area E, and their end (shaded portion of the figure) is located beyond X-X axis, while the external termination 114b ends on the external borders of the projection areas F and G. FIG. 16-a shows that, as it occurs with the front tire, the width q of the grooves near the external border is larger than width p in the medium portion of these grooves. Further as shown by FIGS. 10 and 16, such grooves are circumferentially staggered.

Preferably, each of such intermediate side areas C, D has a width from about 20% to 30% and, more precisely, 25% of the tread shown in FIG. 10. The sea/land ratio is from about 20% to about 40% and in the example tread of the figure, it has a value equal to 33%.

As shown in FIG. 10, rear tire 101 further comprises a plurality of transversal intermediate grooves 116 intercalated between grooves 114. Such intermediate grooves have their axially internal ends substantially located in the border line between the central area E and intermediate side areas C, D, the external ends ending inside projection areas F, G. of tread 12.

Further as shown in the figure, as it occurs with front tire 1, rear tire 101 also has its tread provided with branches 115a, 115b of transversal grooves 114, 116 that comprise bridging grooves interconnecting such transversal grooves.

Preferably, the portions of transversal grooves 114 and 116 located in the intermediate side areas C or D form with the running direction DR of the tire angles a and b from about 50° to about 75° and, more preferably, from about 60° to about 70°, this angle be equal to 66° and 67°, respectively, in the tread shown in FIG. 10.

Additionally, the tread drawing of this rear tire comprises grooves 117a and the narrow slots 117b respectively located in projection areas F, G and in the intermediate side areas C, D. The former are intended to improve the draining and curved paths, providing a proper balance between the areas occupied by grooves and those occupied by rubber portions, while slots 117b increase the flexibility of the tire along areas C and D.

According to the invention, a motorcycle equipped with a front tire 1 and rear tire 101, as described above, respectively, mounted on its front wheel and on its rear wheel may advantageously reach better performance both on dry and wet ground, associated to a better mileage output, better uniformity of wearing and better traction characteristics.

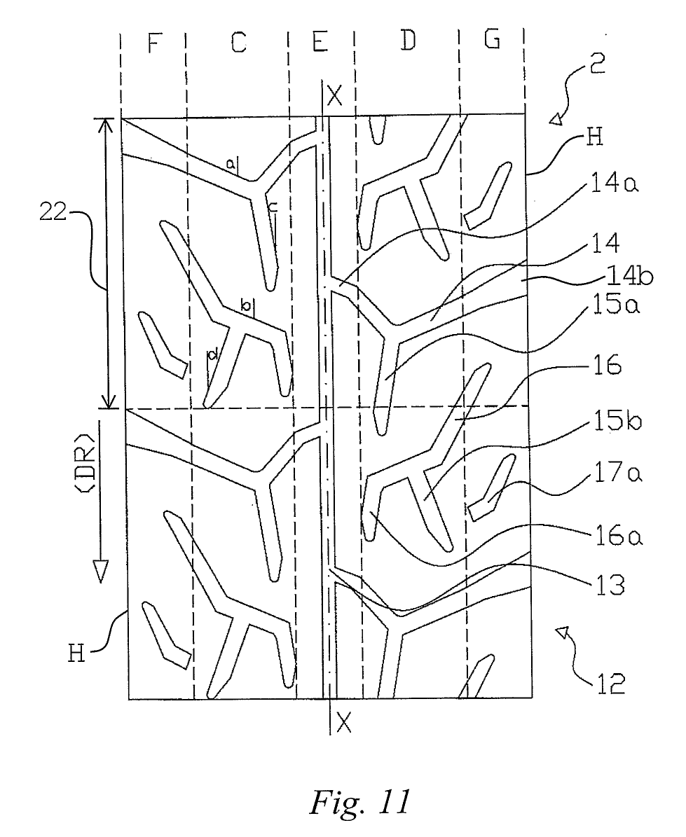

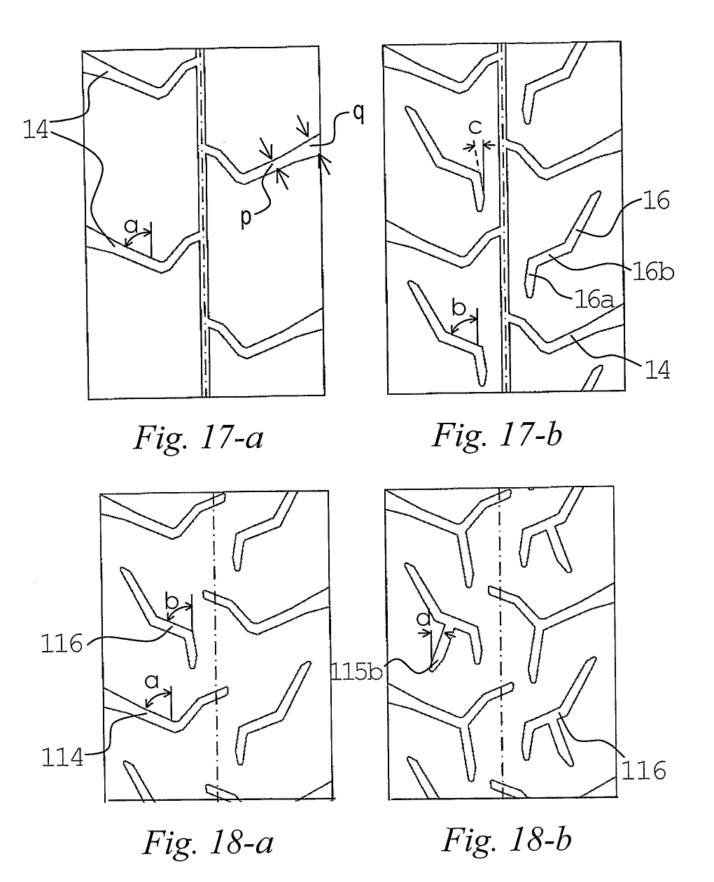

FIGS. 11 and 17 show the tread of the front tire according to a second embodiment of the invention. The sea/land ratios in this case are as follows:
In the central area E, from about 10% to about 30%, and in the tread shown in FIG. 11 is equal to 26%;
in intermediate side areas C and D, from about 20% to about 40%, and this relation is equal to 31% in the drawing of FIG. 11;
in projection areas F and G, from about 15% to about 25%, and its value is equal to 17% in the drawing of FIG. 11;

Preferably, transversal grooves 14 form with the running direction DR of front tire 1, which is parallel to X-X axis, an angle a from about 50° to about 75° and more preferably, from about 60° to about 70°, this angle being equal to 66° in FIG. 11. As with the first embodiment of the invention, the front tire is provided with a circumferential groove 13, centrally located along the X-X axis and of a plurality of transversal grooves 14, circumferentially staggered, the internal ends 14a of which are connected to said circumferential groove 13. Such transversal grooves present, in their external extremities 14b—that end on the external borders of the projection areas F and G—a width q larger than width p in its medium region. Besides, such grooves 14 are circumferentially distributed along the tread 12 in a staggered manner.

As shown in FIGS. 11 and 17, in the second embodiment of the invention, the tread of the front tire is provided with a set of intermediate grooves 16, intercalated between grooves 14. Such intermediate grooves are formed by three straight-line sections in zigzag 16 and 16a in the ends and 16b in the center, and it is nearly parallel to grooves 14. The internal end of section 16a is substantially located in the border line between the central area E and the intermediate side areas C or D. Section 16 has its end in the projection area (F or G, according to the band side considered).

In order to improve the water draining in the intermediate side areas, grooves 15a and 15b are provided, respectively joined to grooves 14 and 16b, and extending in a direction near that of the rolling DR, making with it an angle c of 9° and a angle d of 20°, as shown in FIGS. 9 and 11. Further according to this figure, tread 12 is provided with grooves 17a, located in the projection area, the purpose of which is to improve the water draining when this area touches the floor, in the sharp curved paths.

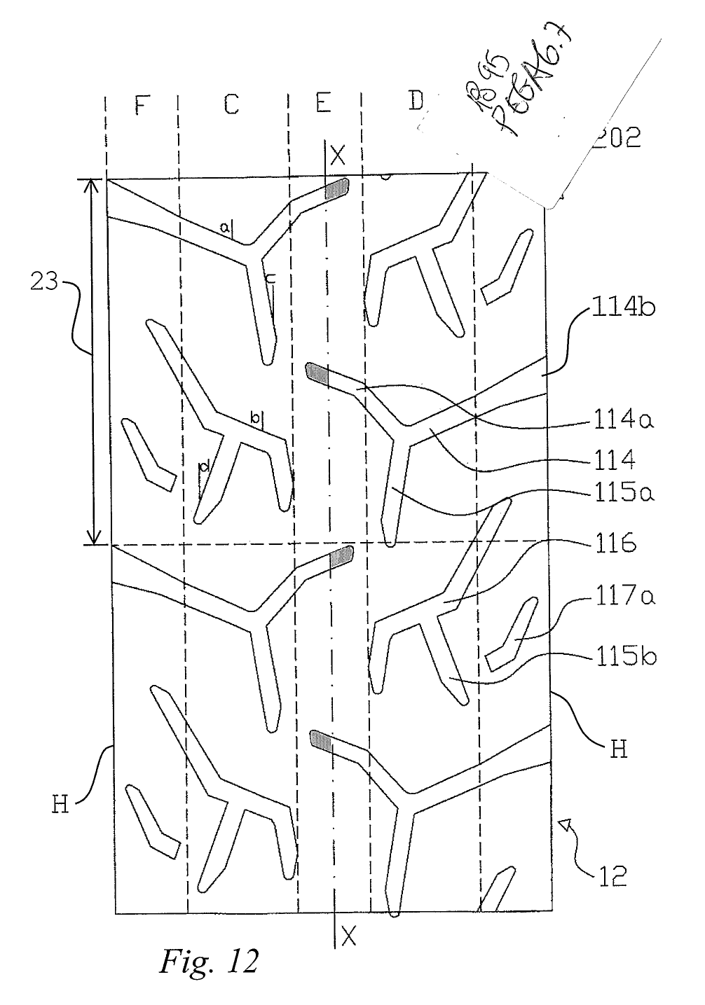

FIGS. 12 and 18 show the tread of the rear tire in the second embodiment of the invention. This tread differs from that of the front tire with which it forms a pair, as shown in FIGS. 11 and 17, particularly due to the fact that it does not have a circumferential central groove 13. As a consequence of this, a higher amount of rubber results in central area E of this rear tire, which implies a smaller value in the sea/land ratio, which, in the tread shown in FIG. 12 is only 7%. According to the principles of the invention, the internal portion of grooves 114a extends along central area E, and its end (shaded in FIG. 12) is located beyond the X-X central axis. Besides helping water drainage in the contact patch with the floor, this embodiment permits to check the wear of the tread in this area.

The other elements of the tread shown in FIG. 12 are similar to those shown in FIG. 11, and such treads differ from each other only in the circumferential spacing between the tread layout modules, that is, dimension 23 in FIG. 12 is larger than dimension 22 in FIG. 11. The result of this spacing is that the rear tire, in this second embodiment, has more rubber in its tread in comparison with that of the rear tire of the first embodiment, that is, the sea/land ratio is higher in this first embodiment. Such difference may be better viewed through the comparative chart below, which is based on the specific drawings of FIGS. 10 and 12.

| | Sea/land ratio in the | Sea/land ratio in the |
|---|---|---|
| Area | First Embodiment | Second Embodiment |
| Central E | 10% | 7% |
| Intermediate Side | 33% | 23% |
| Projection | 25% | 16% |

This larger amount of rubber results in a performance comparatively more “sporting” of the pair of tires manufactured according to the second embodiment.

The treads contained in FIGS. 11 and 12 further show that transversal grooves 14, 16, 114 and 116 are provided with branches comprising grooves 15a, 15b, 115a and 115b, forming, with DR direction or X-X angles comprised between about 5° and about 25°. In treads contained in FIGS. 11 and 12, angles c e d of these branches are, respectively, equal to 9° and 20°. Contrarily to what happens with the tires of the first embodiment of the invention (FIGS. 9 and 10), the branching grooves in the second embodiment of the invention do not form bridges between the surrounding transversal grooves. In other words, branching groove 15a that derives from transversal groove 14 does not reach groove 16; in a similar manner, branching groove 15b that derives from transversal groove 16 does not reach groove 14.

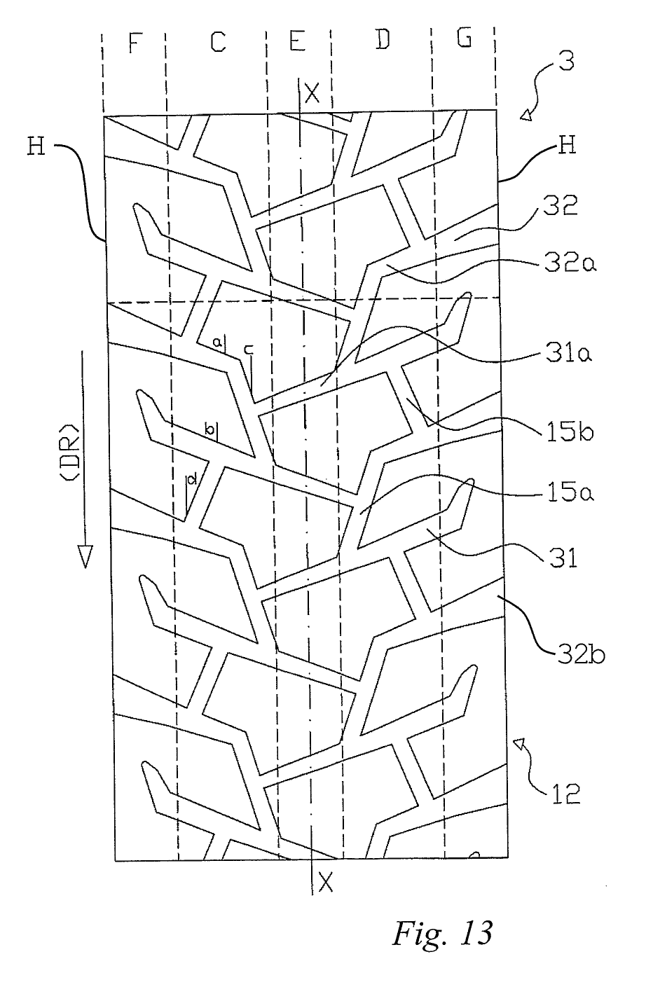

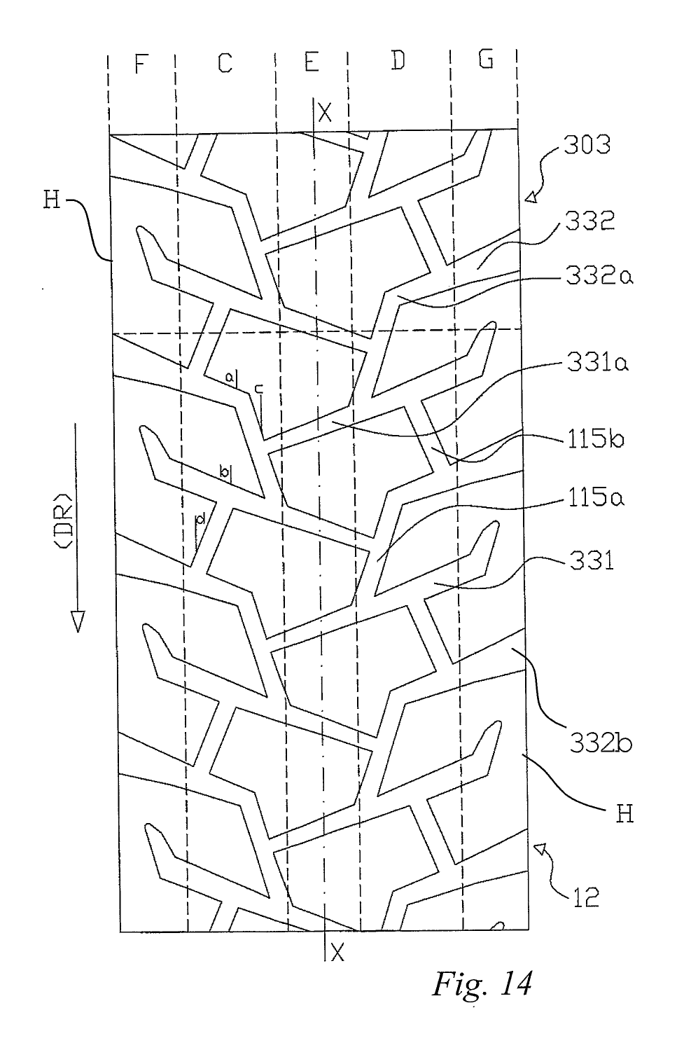

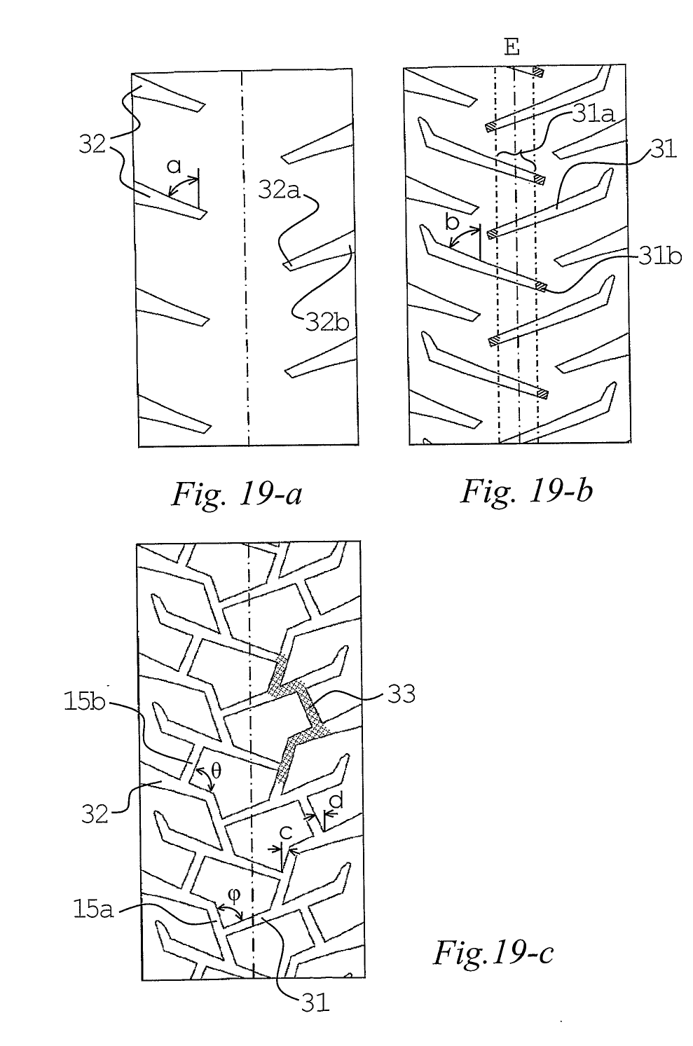

FIGS. 13 and 19 show the tread corresponding to the third embodiment of the invention, the characteristics of which are adequate to the traffic on unpaved floors. In this embodiment, the proportions between the elements of the drawings of tread for the front and rear tire are equal, and such drawings differ only in dimensions that are larger in the rear tire.

Due to the similarity, the sea/land proportions in the several areas of these tires are virtually identical in both tires, comprising values between 15% and 20% in central area E, between 25% and 40% in intermediate side areas C, D and between 20% and 30% in projection areas F and G.

As shown in FIGS. 19-a, 19-b and 19-c, the drawing of the tread comprises transversal grooves 32 that have their inner end 32a in intermediate side area C, D and its outer end 32b in the external border of corresponding projection area F, G. According to the principles of the invention, the width of the groove in this second end 32b is larger than in such first end 32a. As shown in FIG. 13 and in FIG. 19-a, the upstream edge of grooves 32 makes, with the rolling direction DR, an angle preferably between about 60° and about 70°, this angle being equal to 67° in the tread shown in the picture.

The drawing of the tread further presents, intercalated between grooves 32, transversal grooves 31 that diagonally extend between projection area F, G, cross the intermediate side area C, D as well as the central area E, surpassing it entirely and ending beyond the border line between such central area and the intermediate area D or C of the opposite side. For the sake of clarity, this terminal portion is shaded in FIG. 19-b. The angle between the upstream border of these grooves and rolling direction DR is, preferably, between about 60° and about 70°. In the tread shown in the figure, this value is equal to 67°.

Additionally, the treads, both in the front and in the rear tire, in this third embodiment of the invention, include branching grooves 15a and 15b, that comprise two sets of bridging grooves between such transversal grooves. Grooves 15a of the first set are located between internal ends 32a of transversal grooves 32, located at one side of the tread, and transversal grooves 31 located at the same side of the tread. Said grooves 15a, that are located in internal side areas are joined to edges 31b of grooves 31 that begin on the opposite side of the tread. As shown in FIG. 19, bridging grooves 15a form, with the rolling direction DR, an angle c comprising between 5° and 25°. In the figure, this angle has the value of 18°. It is further seen in FIG. 19-c, that the angle φ between the bridging grooves 15a and the grooves 31 of the opposed side is approximately of 90°.

The second set of bridging grooves comprises grooves 15b, equally located in the intermediate side areas, joining the center of transversal grooves 32 and the first third of transversal grooves 31 of the same side of tread. As shown in the picture, the angle θ between such bridging grooves and grooves 32 is of about 90°. In this embodiment, bridging grooves 15a form, with the rolling direction DR, an angle d comprised between 5° and 25°. In the figure, this angle has the value of 23°.

It is found, therefore, that such bridging grooves form, together with a portion of the transversal grooves to which they are connected, continuous paths 33 in zigzag—one of these indicated by the shading in FIG. 19-c—which extend substantially in parallel to the central axis and on both sides of it, increasing the efficiency in water drainage.

Repeated tests performed by the applicant have shown that the three pairs of motorcycle tires according to the invention are capable of solving in a fully satisfactory manner the problem proposed of perfecting both the performance on moist or wet ground and the mileage output, uniformity of wearing and traction characteristics of motorcycle tires.

These results and particularly the performance improvement on wet ground may be considered fully surprising, considering that these are reached through the reduction in the rear tire of the number of grooves in the most critical area which is the central area of the tread, by reducing the number of those structural elements—the grooves—to drain the water out from the area of contact with the ground.

Obviously, those skilled in the art may introduce variations and changes to the invention described above, with the purpose of meeting specific and contingent demands, which variations and modifications are included in the scope of protection as defined by the following claims.

1-24. (canceled)

25. A pair of motorcycle tires comprising a front tire and a corresponding rear tire capable of being mounted, respectively, on front and rear wheels of a motorcycle, said front and rear tires comprising a tread comprising a plurality of low-relief grooves forming a drawing of the tread, said drawing comprising repetition of substantially identical modular sections which repeat along a tire circumference, said tread comprising a central area encircling an equatorial plane of the tire, sided by intermediate side areas and by projection areas, the projection areas being adjacent to external borders of such tread, wherein:
said central area has a width between about 10% and about 25% of the total width of the tread;
each of the intermediate side areas has a width between about 20% and about 30% of the total width of the tread;
each of the projection areas has a width between about 10% and about 20% of the total width of the tread;
the sea/land ratio in the central area of the front tire is between about 15% and about 30%;
the sea/land ratio in the central area of the rear tire is substantially lower than the sea/land ratio of other areas of the tire, and the value of the sea/land ratio of the central area is lower than 20%;
the sea/land ratio in intermediate side areas of the front tire and rear tire is between about 20% and about 40% and, in all cases and for each tire, is higher than the sea/land ratio in the central and projection areas; and
the sea/land ratio in the projection areas of the front tire and rear tire is between about 10% and 30%.

26. The motorcycle tires, according to claim 25, wherein the grooves provided in the tread of the tires comprise transversal grooves angularly laid out in relation to a running direction of the tire.

27. The motorcycle tires, according to claim 26, wherein the transversal grooves comprise at least one substantially straight section.

28. The motorcycle tires, according to claim 27, wherein the transversal grooves comprise grooves comprising two or more substantially straight sections mutually engaged.

29. The motorcycle tires, according to claim 27, wherein the transversal grooves have, at least, a portion of an extension located within one of the intermediate side areas.

30. The motorcycle tires, according to claim 29, wherein a portion of the transversal grooves located within one of the intermediate side areas forms an angle between about 50° and about 75° with a running direction of a corresponding tire.

31. The motorcycle tires, according to claim 29, wherein the tread has a first set of transversal grooves, the external extremities of which end in borders of the tread, said grooves having at the ends a cross-section greater than the cross-section exhibited by said grooves in the side areas.

32. The motorcycle tires, according to claim 31, wherein the tread comprises a second grooves set, intermediate between the grooves of the first grooves set, and equally positioned in both sides of a longitudinal axis.

33. The motorcycle tires, according to claim 32, wherein the grooves of said second set have a first end approximately at the borderline between the central area and one of the intermediate side areas and a second end at the projection area, without reaching an external border.

34. The motorcycle tires, according to claim 32, wherein the tread comprises a third set of transversal grooves angularly laid out and alternately positioned, said grooves being fully contained in the projection areas.

35. The motorcycle tires, according to claim 27, wherein the transversal grooves have branched grooves, which are located in the intermediate side strips.

36. The motorcycle tires, according to claim 35, wherein the branched grooves form angles between about 5° and about 25° with a running direction of the tire.

37. The motorcycle tires, according to claim 36, wherein the branched grooves form bridge connecting grooves between adjacent transversal grooves.

38. The motorcycle tires, according to claim 31, wherein the tread of the front tire comprises, at least, one circumferential groove extending in the equatorial plane of the front tire within the central area and internal ends of the grooves in said first set are joined, at least, to said at least one circumferential groove.

39. The motorcycle tires, according to claim 31, wherein, in the rear tire, internal ends of the grooves in the first groove set surpass a longitudinal axis in the central area positioned in a side opposed to a higher extension.

40. The motorcycle tires, according to claim 25, wherein the treads of the front and rear tires show similar drawings, differing only in dimensions.

41. A method to improve performance and resistance to the wearing of motorcycle tires, comprising the following steps:
a) improving water draining capacity of a front tire under a contact patch thereof with ground within a central area astride an equatorial plane of the front tire, by providing at least one groove at least partially extending over said central area;
b) improving traction capacity and durability of a rear tire by providing a considerably reduced sea/land ratio within a central area of tread extended over the central area in an equatorial plane of the rear tire, the ratio being substantially lower than that in other areas of the tread; and
c) improving the water draining capacity of both tires, when running on a curved path, through provision of a sea/land ratio in intermediate side areas greater than sea/land ratio in the central and projection areas, said sea/land ratio in said intermediate side areas being between about 20% and about 40%.

42. The method, according to claim 41, wherein step (a) is performed by providing the front tire with a plurality of transversal grooves with an axially internal end located within the central area of the tread in the front tire, and alternately extending from such central area toward projection areas axially opposed to the tread external to the central area of the front tire.

43. The method, according to claim 41, wherein step (a) comprises providing a sea/land ratio between about 10% and about 30% within a central area of the tread of the front tire, the central area having a width of about 10% to about 25% of axial development of such tread.

44. The method, according to claim 41, wherein step (a) comprises providing at least one circumferential groove extending in the equatorial plane of the front tire and, at least, some of the transversal grooves being connected with such at least one circumferential groove.

45. The method, according to claim 41, wherein step (c) comprises providing a plurality of transversal grooves defining a sea/land ratio between about 20% and about 40% within axially opposed intermediate side areas located between the central area and projection areas of the tread, each of the intermediate side areas having a width of about 20% to about 30% of the axial development of such tread of the front tire.

46. The method, according to claim 42, wherein the transversal grooves formed in the tread of the front tire define an angle of about 50° to about 75° with a running direction of the front tire.

47. The method, according to claim 41, wherein the tread comprises a plurality of transversal grooves with an axially internal end located within the central area of the tread in the rear tire, and alternately extending from the central area toward projection areas, axially opposed, external to the central area.

48. The method, according to claim 47, wherein the transversal grooves formed in the tread of the rear tire define an angle of about 50° to about 75° with a running direction of the rear tire.
